(19) United States
(12) Patent Application Publication
(10) Pub. No.: US 2010/0203878 A1
(43) Pub. Date: Aug. 12, 2010

(54) PORTABLE DEVICE INCLUDING A DIGITAL WALKIE-TALKIE MODULE

(75) Inventors: Yong Min Kim, Gyeonggi-do (KR); Kyoung Doo Park, Gyeonggi-do (KR); Hee Yang, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/701,883

(22) Filed: Feb. 8, 2010

(30) Foreign Application Priority Data
Feb. 10, 2009 (KR) 10-2009-0010721
Feb. 10, 2009 (KR) 10-2009-0010722

(51) Int. Cl. H04M 3/00; H04B 1/38; G06F 3/00

(52) U.S. Cl. 455/418; 455/90.2; 455/567; 715/700

(57) ABSTRACT

Provided is a portable device using a digital walkie-talkie module, which includes: a radio frequency unit which forms a call channel based on a mobile communications system; a digital walkie-talkie module which forms a communications channel based on a public frequency band; an input unit which generates an input signal for activation of at least one of the radio frequency unit and the digital walkie-talkie module; an audio processing unit which outputs at least one of an audio signal received by the radio frequency unit and an audio signal received by the digital walkie-talkie module, and collects an inputted audio signal and sends the collected audio signal to one of the radio frequency unit and the digital walkie-talkie module; and a controller which controls processing of a digital signal sent from the digital walkie-talkie module and outputs the processed digital signal to the audio processing unit, or to process an inputted audio signal and send the processed audio signal to the digital walkie-talkie module.

### CLAIM OF PRIORITY

This application claims, pursuant to 35 USC 119(a), priority to, and the benefit of the earlier filing date of, Korean Patent Application No. 10-2009-0010722 and 10-2009-0010721 filed in the Korean Intellectual Property Office on Feb. 10, 2009 and Feb. 10, 2009, the entire contents of which are incorporated by reference, herein.

### BACKGROUND OF THE INVENTION

1. Field of the Invention

The present invention relates to a portable device, and more particularly, to a portable device including a digital walkie-talkie module and control method thereof.

2. Description of the Related Art

A portable device is one of those electronics products that have been rapidly developed due to their advantage of simplicity and convenience. Recently, various options, which enable to store and play information desired by portable device user, e.g., the MP3 function, the DMB function, the video play function, and the camera function have been added to the portable device to further increase its convenience. While being combined with a mobile communications function, such portable device can provide the function of communicating with other portable device users. However, among the portable device functions, the mobile communications function is designed to use the mobile telecommunications network. Thus, a certain cost, according to the use of mobile communications service, has to be paid to a service provider that built the mobile telecommunications network. Such a cost is gradually decreased due as the number of subscribers increases. However, the cost of the mobile communications service has been fixed. In the meantime, the portable device user continuously uses the mobile communications service as the usage range and time rapidly increases. Accordingly, it is the trend that the burden of the portable device user for the cost of the mobile communications service is gradually increased as the network and the reach of the network increases.

### SUMMARY OF THE INVENTION

The present invention provides a portable device using a digital walkie-talkie module and control method thereof, which is capable of maintaining a proper communications channel while reducing the cost. A user interface and support method thereof is also disclosed.

In accordance with an aspect of the present invention, a portable device using a digital walkie-talkie module includes: a radio frequency unit which forms a call channel based on a mobile communications system; a digital walkie-talkie module which forms a communications channel based on a public frequency band; an input unit which generates an input signal for activation of at least one of the radio frequency unit and the digital walkie-talkie module; an audio processing unit which outputs at least one of an audio signal received by the radio frequency unit and an audio signal received by the digital walkie-talkie module, and collects a speaker audio signal and sends it to one of the radio frequency unit and the digital walkie-talkie module; and a controller that controls the processing of a digital signal sent from the digital walkie-talkie module and outputs digital signal to the audio processing unit, or the processing of a signal input through a microphone of the audio unit and sends it to the digital walkie-talkie module.

In accordance with another aspect of the present invention, a method of controlling a portable device including a radio frequency unit forming a call channel based on a mobile communications system and a digital walkie-talkie module forming a communications channel based on a public frequency band, the method includes: forming a call channel based on the radio frequency unit; forming a communications channel by performing a frequency setting for the communications channel formation, in case an input signal for activation of the digital walkie-talkie module based communications channel is generated during the call channel formation; and processing a signal transmitted and received through the digital walkie-talkie module by a signal processing unit which processes a signal transmitted and received through the radio frequency unit.

In accordance with another aspect of the present invention, a method of controlling a portable device including a radio frequency unit forming a call channel based on a mobile communications system and a digital walkie-talkie module forming a communications channel based on a public frequency band, the method includes: forming a communications channel based on the digital walkie-talkie module; and signal-processing a signal transmitted and received through the digital walkie-talkie module by a signal processing unit which processes a signal transmitted and received through the radio frequency unit.

In accordance with another aspect of the present invention, a user interface of a portable device including a digital walkie-talkie module and a mobile communications module includes: a user information area which outputs user information of at least one other portable device; and a communications module area which outputs information which indicates whether the user information is possible to form a communications channel or indicates that a communications channel is formed based on at least one of the digital walkie-talkie module and the mobile communications module.

In accordance with another aspect of the present invention, a method of providing a user interface of a portable device including a mobile communications module forming a communications channel based on a mobile communications system and a digital walkie-talkie module forming a communications channel based on a public frequency band, the method includes: activating a phone book according to a menu selection or a shortcut key input; outputting user information of at least one other portable device according to the activation of phone book; transmitting and receiving a signal for checking whether the user information is possible to form a communications channel according to a given cycle based on a digital walkie-talkie module; and displaying the user information which is possible to form a communications channel based on the digital walkie-talkie module in such a manner that it can be distinguished from other user information.

As described above, according to a portable device using a digital walkie-talkie module and control method thereof, which is describe in the present invention, and a user interface and support method thereof, mobile communications service costs can be saved in a region where the walkie-talkie communications is possible, and the production cost for manufacturing portable device using the digital walkie-talkie module can be minimized.

### BRIEF DESCRIPTION OF THE DRAWINGS

The above features and advantages of the present invention will be more apparent from the following detailed description in conjunction with the accompanying drawings, in which:

FIG. 1 is a drawing schematically illustrating a configuration of a portable device according to an exemplary embodiment of the present invention;

FIG. 2 is a drawing illustrating a configuration of a controller of FIG. 1 in detail;

FIG. 3 is a drawing illustrating a configuration of a digital walkie-talkie module of FIG. 1;

FIG. 4 is a flowchart illustrating a control method of a portable device according to an exemplary embodiment of the present invention;

FIG. 5 is a screen illustrating an example of phone book screen according to an exemplary embodiment of the present invention;

FIG. 6 is a screen illustrating an example of busy state of walkie-talkie according to an exemplary embodiment of the present invention;

FIG. 7 is a screen illustrating an example of call standby state according to an exemplary embodiment of the present invention; and

FIG. 8 is a screen illustrating an example of message service transmission state according to an exemplary embodiment of the present invention.

### DETAILED DESCRIPTION OF THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

The meaning of terms is clarified in this disclosure, so the claims should be read with careful attention to these clarifications. Specific examples are given, but those of skill in the relevant art will understand that other examples may also fall within the meaning of the terms used, and within the scope of one or more claims. Terms do not necessarily have the same meaning here that they have in general usage, in the usage of a particular industry, or in a particular dictionary or set of dictionaries. In the event of an irresolvable conflict between a term's meaning as used expressly herein and the term's meaning as used in an incorporated document, the express meaning herein governs. Although this disclosure and the associated drawings fully detail several alternate preferred embodiments of the present invention, further alternate embodiments can be implemented without departing from the scope of this invention. Consequently, it is to be understood that the following disclosure is provided for exemplary purposes only and is not intended as a limitation of the present invention. Furthermore, all alternate embodiments which are obvious modifications of this disclosure are intended to be encompassed within the scope of the present invention.

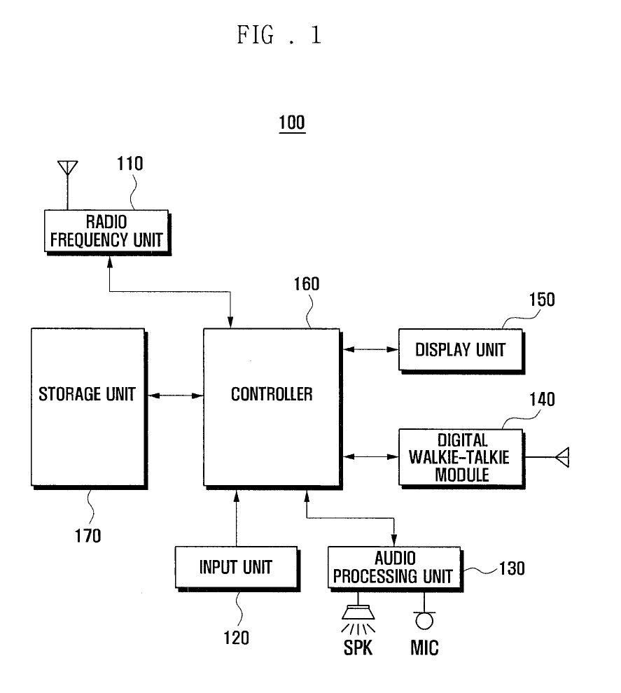

FIG. 1 is a drawing schematically illustrating a configuration of a portable device according to an exemplary embodiment of the present invention.

Referring to FIG. 1, elements of a portable device 100 according to an exemplary embodiment of the present invention are illustrated.

Referring to FIG. 1, the portable device 100 may include a radio frequency unit 110, an input unit 120, an audio processing unit 130, a display unit 150, a digital walkie-talkie module 140, a storage unit 170 and a controller 160. The portable device 100 according to an exemplary embodiment of the present invention having such configuration can perform the voice communications based on the radio frequency unit 110. The portable device 100 can also support and form a communications channel based on the digital walkie-talkie module 140. In accordance with the principles of the invention, the portable device 100 is able to process a signal received through the digital walkie-talkie module 140 by using a signal process module which is prepared for the support of radio frequency unit 110, thereby improving the quality of the voice communications. Hereinafter, each configuration is illustrated in detail.

Firstly, the radio frequency unit 110 performs the transceiving function of a signal related to the mobile phone communication, a short message service (SMS) or a multimedia message service (MMS), voice communications and/or data communications or the like. Moreover, the radio frequency unit 110 converts voice/sound data and control data into a radio signal and transmits the converted radio signal, and receives a radio signal and converts the radio signal into voice/sound data and control data and outputs the data. To this end, the radio frequency unit 110 includes a radio frequency transmitter which up-converts and amplifies a frequency of a transmitting signal and a radio frequency reception unit which low-noise amplifies a receiving signal and down-converts the received frequency. Particularly, the radio frequency unit 110 can be determined according to the point of time of the activation of digital walkie-talkie module 140 under the control of the controller 160. That is, if the digital walkie-talkie module 140 is activated when performing the call through a communications channel formed using the radio frequency unit 110, the radio frequency unit 110 can maintain or cancel the communications channel under the control of the controller 160. The above-described radio frequency unit 110 may be one a number of different mobile communications modem such as a GSM modem, which can support mobile communications service using GSM network, and/or a CDMA modem, which can support mobile communications service using CDMA network.

The input unit 120 includes a numeric, a character and/or a function key for inputting number and character information and setting various functions. In addition, an input signal for cancelling the voice call channel, an input signal for activating the digital walkie-talkie module 140, and an input signal for cancelling the communications channel formed by the digital walkie-talkie module 140, may also be generated by the input unit 120 and sent to the controller 160. The input unit 120 can also generate an input signal for the activation of a menu, an input signal for the selection of phone book, and an input signal for selecting a specific item included in a phonebook list according to user's request and send the generated input signals to the controller 160. The audio processing unit 130 performs the function of playing an audio signal sent from the controller 160 through a speaker (SPK) or transmitting an audio signal such as voice inputted from a microphone (MIC) to the controller 160. That is, in response to the control of the controller 160, the audio processing unit 130 converts voice/sound data into an audible sound through the speaker (SPK) and outputs the converted audible sound, and converts an audio signal, such as voice received from the microphone (MIC), into a digital data signal to be outputted to the controller 160. The audio signal can be one of a signal which is received from the radio frequency unit 110 and decoded and demodulated or a signal which is received from the digital walkie-talkie module 140 and decoded and demodulated. In case the digital walkie-talkie module 140 is manufactured as a detachable unit, the audio processing unit 130 can output an audio signal for providing information to the use of the connection or the separation of the unit when it is connected or separated from the portable terminal. The audio processing unit 130 can output an alarm as an audio signal when it is possible to break away from coverage or when it breaks away from coverage while communicating based on the digital walkie-talkie module 140.

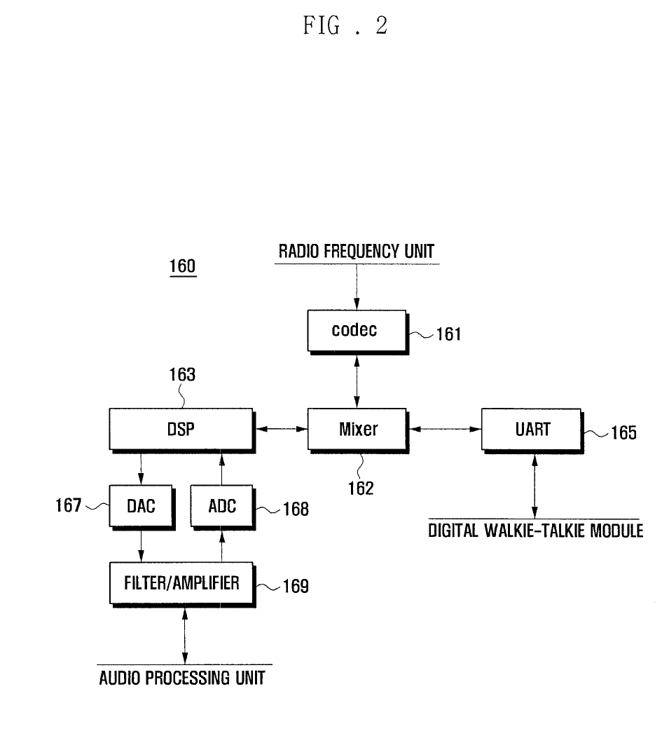

The digital walkie-talkie module 140 is a walkie-talkie module which can send and receive a signal based on an ISM (industrial scientific and medical) band, and can send a signal without paying a separate frequency utilization cost. Here, the ISM band is a frequency band that is used for an industrial, scientific, and medical purpose. As for the ISM facility, only a transmitted basic wave and a tolerance of electric field intensity of spurious emission are prescribed. Although there is no limit on a serving frequency, the ISM frequency band is designated by the International Telecommunication convention annex radio regulations (RR), and the limit of leakage electric field intensity of the ISM frequency band is not set. In case of forming a communications channel with other portable devices according to a user's setting, the digital walkie-talkie module 140 can attempt to primarily form a communications channel in comparison with the radio frequency unit 110. A configuration of the digital walkie-talkie module 140 is illustrated in detail with reference to FIG. 2, for example.t.

The display unit 150 displays video data outputted from the controller 160, user data requested from user and a supplementary function screen. Here, the display unit 150 can include a liquid crystal display (LCD). However, the display unit is not limited to an LCD. The display unit of the invention can apply to an Organic Light Emitting Diodes (OLED) and other display technologies. Particularly, the display unit 150 of the invention can output a variety of screens such as a screen displaying a call waiting and a screen displaying a call channel canceling based on a radio frequency unit 110 according to a call transmission screen or a call reception screen, and a call formation based on a screen interface necessary to form a communications channel with other portable devices based on the radio frequency unit 110, e.g., a number input screen and an inputted number.

Moreover, the display unit 150 can output a frequency scan screen for the driving of the digital walkie-talkie module 140, a call channel formulation screen according to a selection frequency which can be communicated, and a message corresponding to the radio frequency unit 110 based call reception during the digital walkie-talkie module 140 based call. That is, the display unit 150 of the invention can output a radio frequency unit 110 based call management screen and a digital walkie-talkie module 140 based call management screen. Moreover, as described above, the display unit 150 of the invention can output a phone book screen which can check the usage availability of the radio frequency unit 110 and the digital walkie-talkie module 140. That is, the display unit 150 of the invention can output an area associated with other portable device user information and an area which displays whether it is possible to form a communications channel based on mobile communications module, i.e., at least one of radio frequency unit 110. When it is possible to break away from coverage or when the radio frequency unit breaks away from coverage during the walkie-talkie call, the display unit 150 can output a relevant warning message, or can output a pop-up window that informs the user of the operational conversion or requests the operational conversion to the radio frequency unit 110. Moreover, the display unit 150 can output a message according to a call request requested from other portable device when forming a communications channel based on at least one of the radio frequency unit 110 or the digital walkie-talkie module 140, and can output a screen which transmits a message based on the digital walkie-talkie module 140. A user interface which is outputted through the display unit 150 is illustrated in detail with reference to drawings and will be discussed in further detail shortly.

The storage unit 170 can store an Operating System (OS) for the booting, and operation, of the portable device, and application programs for each function of the portable device, e.g., the file playing function, the camera function, and the watching broadcast function or the like. Moreover, the storage unit 170 can store user data which is generated according to the use of portable device, and data which is received through one or more communication channels. To this end, the storage unit 170 can be classified into a program area and a data area. The program area stores application program for supporting each function of the portable terminal. In case one or more of the operational functions is activated in response to user's request, respective functions are provided by using a corresponding application programs under the control of the controller 160. Particularly, the program area can include an application programs for forming and supporting a radio frequency unit 110 based communications channel and an application programs for forming and supporting a digital walkie-talkie module 140 based communications channel. The data area plays a role of storing various data such as data which is generated when performing one or more of the stored applications and data which a user has inputted. Particularly, the data area of the present invention can store phone book data that stores a telephone number for performing a call based on the radio frequency unit 110, and a frequency table for performing a scan based on the digital walkie-talkie module 140. Moreover, the data area can store data which can selectively utilize the digital walkie-talkie module 140 and the radio frequency unit in association with the phone book. The controller 160 performs the function of controlling the overall operation of portable device and a signal flow between internal blocks of the portable device. According to the embodiment of the present invention, the controller 160 controls a signal flow between the elements such as the radio frequency unit 110, the input unit 120, the storage unit 170, the digital walkie-talkie module 140, the audio processing unit 130, and the display unit 150. Particularly, the controller 160 can control the radio frequency unit 110 based call channel formation and the digital walkie-talkie module 140 based call channel formation through one or more application programs stored in the storage unit 170.

To this end, as shown in FIG. 2, the controller 160 can include a codec 161, a mixer 162, a DSP (digital signal processor) 163, a UART (Universal Asynchronous Receiver/Transmitter) interface 165, a DAC (Digital Analog Converter) 167, a ADC (Analog Digital Converter) 168 and a filter/amplifier 169. The codec 161 can decode a signal sent from another portable device through the radio frequency unit 110 and can send this received signal to the mixer 162. Moreover, the codec 161 can encode a signal sent from the mixer 162 and can transmit this signal to the radio frequency unit 110. The mixer 162 can send respective signals sent from the codec 161 and the UART interface 165 to the digital signal processor 163. Moreover, the mixer 162 can send a signal which the digital signal processor 163 processed to the UART interface 165 and the codec 161. In the meantime, in case the radio frequency unit 110 and the digital walkie-talkie module are simultaneously activated so that a signal is simultaneously received from the codec 161 and the UART interface 165, the mixer 162 can simultaneously send respective signals while mixing each signal or can alternatively send respective signals while not mixing each signal. In more detail, in case a signal corresponding to call request is received from the radio frequency unit 110 in the state where the digital walkie-talkie module is activated, the mixer 162 can control provide an output to cause a pop-up window to appear on the display unit (not shown) or to perform vibration alarm indicating a call request reception. If a signal is received through the communications channel after the communications channel is formed with another portable device, through the radio frequency unit 110, the mixer 162 can send the signal to the digital signal processor 163 together with a signal that is received through the UART interface 165 (i.e., transmitted by the digital walkie-talkie module). At this time, the mixer 162 can alternatively send a signal transmitted by the radio frequency unit 110 and a signal received through the UART interface 165 to the digital signal processor 163, or can send the signals to the digital signal processor 163 while mixing the signals. The signal reception according to the formation of communications channel can be identically applicable even when the portable device performs a call request to another portable device and a corresponding communications channel is formed. In the meantime, in case a signal for the formation of a communications channel is sent from the digital walkie-talkie module during the transmission of a signal according to a call service based on the radio frequency unit 110, the mixer 162 can cause the output of a pop-up window or a vibration alarm which checks the formation of communications channel based on the digital walkie-talkie module. Further, the mixer 162 may mix a signal sent through the radio frequency unit 110 with a signal which the digital walkie-talkie module received, and can send the mixed signal to the digital signal processor 163. In summary, in case only one of the radio frequency unit 110 or the digital walkie-talkie module is activated, the mixer 162 plays the role of transmitting a signal sent from a corresponding module to the digital signal processor 163. In case two communications modules are simultaneously attempting to be activated, the mixer 162 sends a signal of previously activated communications module to the digital signal processor 163 and, furthermore, can control a process for checking the formation of communications channel based on a signal received from the other communications module. At this time, in case two communications modules are simultaneously activated and simultaneously receive a signal, the mixer 162 may mix the signal sent from each communications module and can send the mixed signal to the digital signal processor 163. Accordingly, the audio processing unit can output a signal which is received from two communications modules to speaker (SPK).

In the meantime, in case of receiving a signal from the digital signal processor 163, the mixer 162 sends the signal to a route which is connected to the communications module that is being activated according to the controller 160, i.e., the radio frequency unit 110 or the digital walkie-talkie module. At this time, in case the radio frequency unit 110 and the digital walkie-talkie module are simultaneously activated, the mixer 162 can respectively send the signal to each module, e.g., the codec 161 and the UART interface 163. After the digital signal-processing of a signal sent from the mixer 162, the digital signal processor 163 sends the processed signal to the DAC 167. And, after the digital signal-processing of a signal sent from the ADC 168, the digital signal processor 163 sends the processed signal to the mixer 162. Accordingly, as a signal sent from the digital walkie-talkie module digital is processed by the digital signal processor 163, the quality of audio signal can be improved. In case the mixer 162 simultaneously receives and sends a signal from the codec 161 and the UART interface 165, the signals can be processed together, as the digital signal processor 163 performs the digital signal processing of the signals sent from the mixer 162 in view of audio signal output.

The UART interface 165 is an interface which can perform communication with the digital walkie-talkie module 140. Here, the present invention exemplifies a UART (Universal Asynchronous Receiver/Transmitter) method which is a general purpose asynchronous transmission and reception method. However, the UART interface 165 can be replaced with a communications method according to an example of serial communications method, e.g., an interface which supports the USB communications method, the RS-232 communications method, and/or the IPC (Inter Process Communication) communications method. This UART interface 165 performs a serial communications interface function which can send a digital signal sent from the digital walkie-talkie module 140 to the mixer 162. The DAC 167 converts a signal sent from the digital signal processor 163 into an analog signal. And the DAC 167 sends the converted analog signal to the filter/amplifier 169. In the meantime, the ADC 168 converts the analog signal sent from the filter/amplifier 169 into a digital signal. And the ADC 168 sends the converted digital signal to the digital signal processor 163. The filter/amplifier 169 filters the analog signal received from the DAC 167 and removes noise, while amplifying the signal based on a preset gain value and sending the amplified signal to the audio processing unit. And the filter/amplifier 169 can filter and amplify an audio signal collected by the audio processing unit and can send the signal to the ADC 168. As described above, the controller 160 of the present invention can support providing an audio service of high quality by processing a signal transmitted and received through the digital walkie-talkie module by using digital signal processor 163, the speaker, and the microphone of the audio processing unit 130 which are included within the portable device 100. That is, in case a communications channel is formed based on the digital walkie-talkie module, the portable device of the present invention can perform the collection and signal-processing of audio signal by using the microphone within the audio processing unit of the portable device, and transmit to other digital walkie-talkie modules through a communications channel which the digital walkie-talkie module has formed. Moreover, after signal-processing the audio signal received by the digital walkie-talkie module based on the signal processing unit (i.e., DSP 163), the portable device of the present invention can output a more stable and clean audio signal by outputting the signal through the speaker in the audio processing unit 130.

In the meantime, the controller 160 of the present invention can control a radio frequency unit 110 based call channel formation and a digital walkie-talkie module 140 based call channel formation according to user's request or call reception.

In more detail, in case an input signal which requests call channel formation with another portable device is generated based on a telephone number inputted from the input unit 120 or phone book data stored in the storage unit 170, the controller 160 transmits a call connection request message to the other portable device through a mobile communications system based on the corresponding telephone number. If a call connection response message of another portable device is received, the controller 160 can control the voice communication processing, and the message transmission service based on the call channel formed by the radio frequency unit 110 and mobile communications system. At this time, in case the portable device user tries to use a digital walkie-talkie module 140 based call channel, the controller 160 performs a frequency scan based on a frequency table stored in the storage unit 170. To this end, the portable device 100 and other portable device should supply power to the digital walkie-talkie module 140, and the other portable device should be able to maintain a standby state with a specific frequency value. Accordingly, if a key input signal for using the digital walkie-talkie module 140 is generated during the forming of a radio frequency unit 110 based call channel, the controller 160 can transmit an initialization message for the digital walkie-talkie module 140 based call channel formation to other portable devices. The initialization message includes at least frequency value information.

When receiving an initialization message, the controller of other portable device automatically turns the digital walkie-talkie module on, and can perform frequency standby process based on the frequency value included in the initialization message. And if a dummy signal is sent from the portable device 100, which transmitted the initialization message, the controller of the other portable device can transmit a pertinent response signal to the portable device 100. At this time, the controller of the other portable device can issue an alarm that the digital walkie-talkie module based call channel has been formed. In the meantime, the portable device 100, which transmitted the initialization message, sets frequency value of the digital walkie-talkie module 140 based on frequency value included in the initialization message under the control of the controller 160, and can transmit a preset dummy signal with a corresponding frequency value. If a response signal for the dummy signal is received from the digital walkie-talkie module of the other portable device, the controller can control the digital walkie-talkie module to output a message informing the user of the portable terminal 100 of the formation of a the digital walkie-talkie module based call channel through the display unit 150 or the audio processing unit 130. In case the response signal for the dummy signal does not exist, the controller 160 can further perform a repetitive dummy signal transmission for a preset number of times, and can output a call channel formation disable message to the display unit 150 or the audio processing unit 130. In this process, the controller 160 can perform a call which is based on a radio frequency unit 110 based channel. When the call channel is formed based on the digital walkie-talkie module 140, the controller 160 changes the radio frequency unit 110 to a standby state and maintains a standby state of a call from another portable device. In this process, the controller 160 transmits an audio signal collected through the audio processing unit 130 to mobile communications systems, with a route including the digital signal processor 163, the UART interface 165 and the digital walkie-talkie module 140, instead of a route via the digital signal processor 163, the mixer 162, the codec 161 and the radio frequency unit 110. At this time, the controller 160 can send the collected audio signal to both the radio frequency unit 110 and the digital walkie-talkie module 140. Moreover, the controller 160 can output a signal received from the digital walkie-talkie module 140 through the speaker (SPK) of the audio processing unit 130 via the UART interface 165, the mixer 162 and the digital signal processor 163.

On the other hand, the controller 160 can form a call channel based on the digital walkie-talkie module 140 and if a radio frequency unit 110 based call connection request message is received from another portable device during the process of controlling signal processing and transceiving based on a corresponding call channel, the controller 160 can output a relevant alarm to the display unit 150 and the audio processing unit 130. Moreover, in case of receiving a call connection request message from another portable device when operating a digital walkie-talkie module 140 based call, the controller 160 can support a call standby service. That is, it can send a beep sound informing the other portable device of the “busy” state of the portable device 100.

In order to provide a phone book screen, the controller 160 can activate at least one of the radio frequency unit 110 and the digital walkie-talkie module 140 according to a preset cycle.

In more detail, in case the walkie-talkie module may be activated according to user's setting, and the controller 160 can check whether a respective user information stored in the phone book can be communicated with the digital walkie-talkie module in a preset cycle. At this time, the controller 160 checks information regard the user that registers a walkie-talkie module icon from the phone book, and checks whether a walkie-talkie module based communications channel can be formed by selecting only information of that user that registers walkie-talkie module icon. The controller 160 can update the walkie-talkie module icon with respect to information of user that can form communications channel. In the meantime, the controller 160 performs initialization when the digital walkie-talkie module is activated, and can check whether a walkie-talkie module based communications channel can be formed by using user information stored in the phone book. Thereafter, the controller 160 can renew a walkie-talkie module icon area on the display with respect to information of the user that can form a walkie-talkie module based communications channel. Moreover, in the selection of information of a user that can form a walkie-talkie module based communications channel, the controller 160 can check whether a communications channel can be formed by selecting only user information that is set by user. To this end, the portable device can provide a menu which can select information of a user that can communicate with walkie-talkie module among information stored in the phone book. In case, a portable device user selects such user information, the controller 160 can check the walkie-talkie module availability only with the selected user information. And the controller 160 can check whether communications is possible with respect to the mobile communications module in a cycle with the walkie-talkie module. However, it may not perform such checking according to user's setting in consideration of the battery consumption. In case the communications channel is formed based on the walkie-talkie module, the controller 160 detects the intensity of signal (signal strength) which the digital walkie-talkie module receives. And if the intensity of the received signal is less than a predetermined intensity, or if the received signal does not exist, the controller 160 can output a warning message about the breakaway of coverage.

In the meantime, when transmitting messages after the completion of message writing, the controller 160 can check other portable device information and can check whether transmission is possible with these other portable devices based on the walkie-talkie module. That is, the controller 160 can preferentially transmit a written message based on the walkie-talkie module, when the walkie-talkie module icon is activated, by checking phonebook. At this time, the controller 160 can output an image that can be distinguished from a message which is transmitted based on the mobile communications module to the display unit 150 in order to alert the user that the transmitting message is transmitted with the walkie-talkie module. In case the walkie-talkie module based message transmission fails, the controller 160 can transmit a message based on the mobile communications module according to a user's request. To this end, in case the walkie-talkie module based message transmission fails, the controller 160 can output a warning about the message transmission failure in the walkie-talkie mode, and output a pop-up window which queries whether to transmit the message based on the mobile communications module.

The controller 160 may indicate the formation of walkie-talkie module based communications channel based on the phone book, but can perform such function when inputting a telephone number. That is, in case a user inputs a specific telephone number, an abbreviated number corresponding to telephone number, or a phonebook index information on a stand-by screen by making use of the input unit, the controller 160 can check a walkie-talkie module icon state corresponding to a relevant telephone number. At this time, the controller 160 can check information stored in the phone book when the phone book is periodically updated. And in case the phone book renewal is not set, the controller 160 activates the digital walkie-talkie module, so that it can check whether it is possible to form a communications channel with a corresponding digital walkie-talkie module. In case it is possible to form a communications channel with the walkie-talkie module, the controller 160 outputs a message or an alarm corresponding to the walkie-talkie module availability when a “send” button is inputted after inputting a telephone number, so communications based on the walkie-talkie module may be performed. Accordingly, according to user's input, the display unit 150 can include an area that outputs user information of other portable device and an area which displays whether the user information is possible to form a communications channel based on at least one of the digital walkie-talkie module 140 and the radio frequency unit 110. At this time, the other portable device user information can be information that is stored in the phone book, information that a user directly inputted to the input unit, and/or information inputted by a shortcut key.

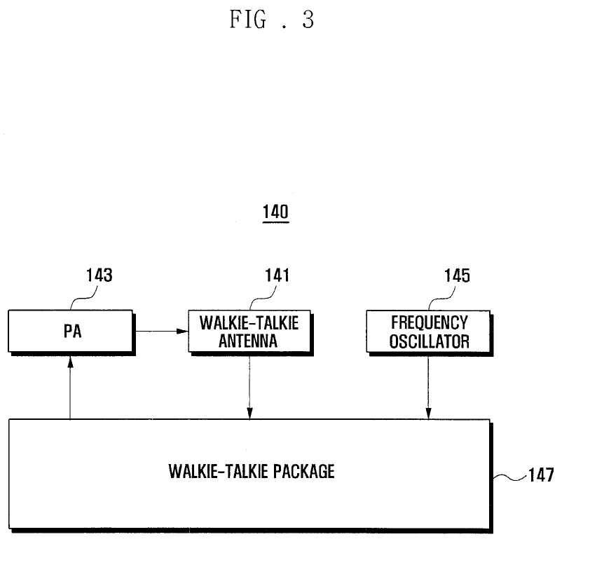

FIG. 3 is a block diagram which schematically illustrates a configuration of the digital walkie-talkie module 140 according to an exemplary embodiment of the present invention.

Referring to FIG. 3, the digital walkie-talkie module 140 of the present invention includes a power amplifier (PA) 143, a walkie-talkie antenna 141, a frequency oscillator 145 and a walkie-talkie package 147. The power amplifier 143 amplifies a signal sent from the walkie-talkie package 147. Since the size of the signal sent from the walkie-talkie package 147 is small, power amplification is necessary to transmit the signal over a certain distance. Accordingly, the power amplifier 143 is provided with power from a power supply unit of the portable device 100 and amplifies a signal transmitted from the walkie-talkie package 147. The walkie-talkie antenna 141 radiates a signal which is sent from the walkie-talkie package 147 and is amplified by the power amplifier 143. Furthermore, the walkie-talkie antenna 141 receives a signal radiated in the air and sends the collected signal to the walkie-talkie package 147. This walkie-talkie antenna 141 can collect only a signal of specific frequency band which is set by the walkie-talkie package 147. Moreover, the walkie-talkie antenna 141 can transmit a signal in specific frequency band generated by the walkie-talkie package 147. The frequency oscillator 145 is an element for generating a reference signal value of a signal created in the walkie-talkie package 147. A reference signal value is necessary to filter the signals in the specific frequency band when transmitting and receiving a signal. The frequency oscillator 145 can perform the role of generating such reference signal value and providing the generated reference signal value to the walkie-talkie package 147. The walkie-talkie package 147 controls the overall operation of the digital walkie-talkie module 140 so that it can support the walkie-talkie communications operation.

To this end, the walkie-talkie package 147 can include a microprocessor unit, a flash memory, and a RAM SOP (Small Outline Package) (not shown). The walkie-talkie package 147 can store a frequency value for the operation of digital walkie-talkie. The walkie-talkie package 147 can convert a digital signal, which is sent from the controller 160, into an analog signal and to amplify, via the power amplifier 143, and radiate the signal through the walkie-talkie antenna 141. Moreover, the walkie-talkie package 147 converts a signal which the walkie-talkie antenna 141 collected into a digital signal, and sends the converted signal to the controller 160 with a serial communications method, for example. As described above, the digital walkie-talkie module 140 of the present invention includes only elements needed for the signal transceiving, and does not include a separate signal processing module. That is, a signal transmitted and received through the digital walkie-talkie module 140 requires a signal processing over a certain level due to an environment characteristic of transmitting and receiving through a public frequency band and a frequency noise characteristic. However, as the digital walkie-talkie module 140 of the present invention is included in portable device 100 signal processing may be performed using the signal processing unit which is provided for the support of radio frequency unit 110.

In the above, a configuration of the portable device using the digital walkie-talkie module according to an exemplary embodiment of the present invention and the role of each configuration were illustrated. Hereinafter, the operating method of a portable device using a digital walkie-talkie module according to an exemplary embodiment of the present invention is illustrated in detail.

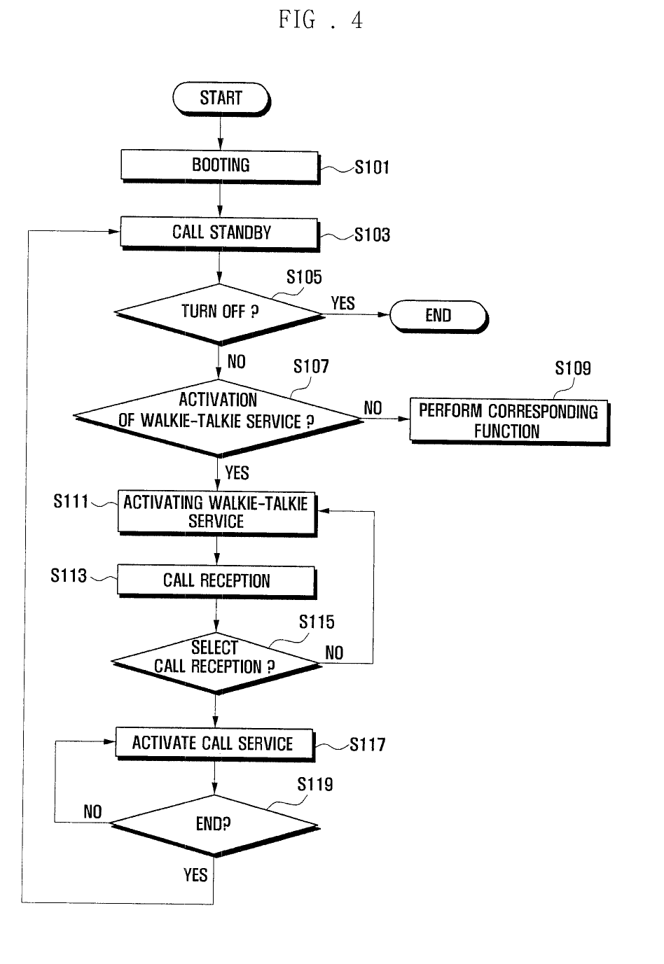

FIG. 4 is a flowchart illustrating a method of operation of a portable device according to an exemplary embodiment of the present invention.

Referring to FIG. 4, the controller 160 can perform a booting process when power is supplied from a power supply unit according to an input signal of the input unit (e.g., a turn-on signal) and an boot/operating program stored in the storage (S101). After the booting process is completed, the controller outputs a preset stand-by screen image to the display unit, and initializes the radio frequency unit and maintains a radio frequency unit based call standby state (S103). In this process, the controller also initializes the digital walkie-talkie module. Then, the controller checks whether an input signal for turning off the portable device is inputted (S105). If an input signal corresponding to the turn-off is sent, the controller blocks the power supply of the power supply unit, and cstops the function of the portable device. However, if a turn-off signal is not sent at step 105, the controller can check the activation of walkie-talkie service (S107). That is, the controller checks whether an input signal for forming a call channel based on a digital walkie-talkie module is generated from the input unit. If an input signal for the activation of walkie-talkie is not sent at step 107, the controller performs a relevant function corresponding to the inputted signal, e.g., the file playing function, the radio frequency unit based call channel function, and/or the message service function (S109). In the meantime, if an input signal for the activation of walkie-talkie service is generated at step 107, the controller performs the activation of a walkie-talkie service (S111). That is, the controller performs activates the digital walkie-talkie module 140 and performs frequency setting using a preset frequency table. The controller then transmits a dummy signal based on a set frequency value. Here, in case a user sets a specific frequency value, the controller can check whether the walkie-talkie communications channel is formed based on the set specific frequency value. If the walkie-talkie module based communications channel is formed, the controller controls the performance of a corresponding communications channel based call. That is, the controller controls the processing of collecting an audio signal from the microphone unit of the audio processing unit, sending the processed audio signal data to the digital walkie-talkie module based on a serial communication interface, for example, and transmitting the processed audio signal data based on the digital walkie-talkie module through the associated antenna. In addition, the controller may receive data that the digital walkie-talkie module has received and that has been converted into a digital signal, and processes the received data using the signal processing unit and outputs t the processed signal data through the speaker of the audio processing unit.

If a radio frequency unit based call is received during the walkie-talkie call (S113), the controller can check whether to receive (i.e., answer) the radio frequency unit based call (S115). To this end, if call is received at step 113, the controller can output a message or a pop-up window to the display unit, or provide a vibration or a dial tone through the audio processing unit so as to alert the user of the receipt of a call. If the call reception selection is not performed at step 115, i.e., if user rejects the call reception, the processing returns to step 111 to maintain the activation of walkie-talkie service. In this process, the controller can send a beep that alerts the other portable device of a “busy” condition at the user's portable terminal device. And, the controller can also temporarily store the telephone number of portable device having made the call request.

However, if the call reception is selected at step 115, the controller activates the call service (S117). In this process, the controller can maintain or inactivate the active state of the digital walkie-talkie module 140 which is being executed (not shown). The controller can also form a mobile communications channel between the mobile communications system and the other portable device according to the call reception selection, and can transmit an audio signal which is collected through the formed mobile communications channel, or output an audio signal received from the other portable device.

The controller nexts checks whether the radio frequency unit based call service is terminated (S119). When the call service is maintained, it returns to step 117 and continues the call service support function.

However, in case an input signal for the call termination is generated, or a call channel is canceled at step S119, the processing returns to step S103 where the radio frequency unit is maintained in a standby state.

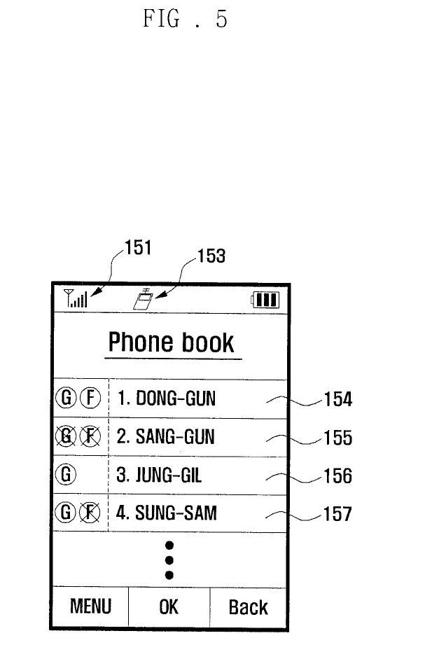

FIG. 5 is a drawing illustrating an example of a display unit of portable device including a digital walkie-talkie module according to an exemplary embodiment of the present invention.

Referring to FIG. 5, in case a user activates a phone book function through a menu selection in the state where the digital walkie-talkie module is activated, the display unit 150 can output phonebook information in the exemplary form illustrated. In the state where the digital walkie-talkie module is activated, a phone book screen can include a reception strength icon 151 indicating the radio state of the mobile communication terminal module in an indicator area, and a walkie-talkie icon 153 indicating the state where the digital walkie-talkie module is activated, and additionally, can include an icon indicating the remainder of battery life of the portable device. The display unit 150 can also output information an identification of the information being displayed in a first area of screen, i.e., “Phone book”, and can output information, stored in the phone book, i.e., a phonebook list, in a second to area of screen of the screen. The phonebook list can output several items which can be outputted to one screen, e.g., four items can be outputted. In case an additional item exists, the display unit 150 can display ellipsis to the lower end of screen. The phonebook list of the present invention can include a communications module area which indicates the availability of communications module on one side and a user information area on a second side. That is, the user information area and the communications module area can be areas for configuring a phonebook area. In detail, the display unit 150 outputs user information regarding “1. Dong-gun” in item 154 to the center and right side of screen, and displays a communications module which can communicate with “1. Dong-gun” as an icon in the left side. The icon indicating the communications module that can be used to communicate with the selected party may indicate a “\textcircled{G}” to represent a mobile communications module and an “\textcircled{F}” to indicate a digital walkie-talkie module. That is, the display unit 150 of the portable device provides the user with the information that communication with “1. Dong-gun” may be based on either the mobile communications module or the digital walkie-talkie module. In the meantime, the display unit 150 outputs information of user(“2. Sang-gun”) in item 155, and further illustrates that no communications module exists to communicate with the corresponding user. That is, presently, the display unit of portable device illustrates that it cannot communicate with another portable device registered as “2. Sang-gun” based on either the mobile communications module or the digital walkie-talkie module. To this end, in the point of time when the phone book is activated, the portable device can perform a signal transceiving process for activating the digital walkie-talkie module and checking whether it can communicate with the user “2. Sang-gun”. In addition, the portable device can perform a signal transceiving process for checking whether it can communicate with “2. Sang-gun” by using a mobile communications module in the same manner. Here, the phone book can show a communications module icon based on a communications history with “2. Sang-gun”. That is, when a case where both the mobile communications module and the digital walkie-talkie module were used to communicate with “2. Sang-gun” based on the call history, the portable device can output the above described icons to the communications module area. Presently, in the state where communication with “2. Sang-gun” is possible, the display unit 150 displays that communications channel cannot be formed based on the mobile communications module or the digital walkie-talkie module, e.g., power is turned off, or it is left in an area where communication is not possible.

Additionally, the display unit 150 displays the element “3. Jung-gil” in the user information area in item 156, and outputs a mobile communications module icon “\textcircled{G}” in the communications module area. Thus, the portable device user can assume that it has never communicated with “3. Jung-gil” based on a digital walkie-talkie module, or “3. Jung-gil” has a portable device that does not have a digital walkie-talkie module.

In the meantime, the display unit 150 displays that it is possible to communicate with other portable device which is being registered as “3. Jung-gil” based on a mobile communications module.

The display unit 150 displays “4. Sung-sam” in user information area in item 157, and displays mobile communications module icon and digital walkie-talkie module icon in the communications module area, while displaying that the digital walkie-talkie module icon cannot be used. Accordingly, the portable device user can recognize that it is possible to communicate with the portable device registered as “4. Sung-sam” based on the mobile communications module, but it is not possible to communicate with that portable device based on the digital walkie-talkie module.

The portable device user can recognize that communications with “4. Sung-sam” has been performed based on mobile communications module and digital walkie-talkie module, or communications with “4. Sung-sam” can be performed based on digital walkie-talkie module. Thus, the display unit 150 of portable device according to an exemplary embodiment of the present invention distinguishes information to the user that can be used to form communication channels with other users based on at least one of the mobile communications module and the digital walkie-talkie module, in a rapid and intuitive manner.

As described above, user interface of the present invention indicates the state where the mobile communications module and the digital walkie-talkie module can be used, so that it supports ease selection of a communication channel with another user the user desires to communicate with. Furthermore, the interface arranges phone book information and icons based on a history of communications module usage, so that the user can rapidly recognize other portable devices that can or cannot communicate using digital walkie-talkie module.

In the meantime, in the above-described description, the communications availability checking based on the mobile communications module can be omitted, and the digital walkie-talkie module based communications availability checking can be performed by using only the digital walkie-talkie module. Accordingly, the display unit of portable device can output only the communications module icon related with the digital walkie-talkie module to an area which outputs the communication module icons.

In the above-described description, the phonebook list output form can be changed according to the intention of a designer or the design shape and a user's setting, and the shapes of icons included therein can be variously displayed. Accordingly, the present invention is not limited to the above-described display type of FIG. 5. That is, it should be understood that the display unit of the present invention displays use information of the communications modules that can communicate with corresponding user information together with user information included in the phone book. Moreover, in the above description, it is illustrated that the communication module icons is displayed in the left side and user information area is displayed in the center and right side. However, the location can be changed or altered by commands designed by user's or a designer's settings.

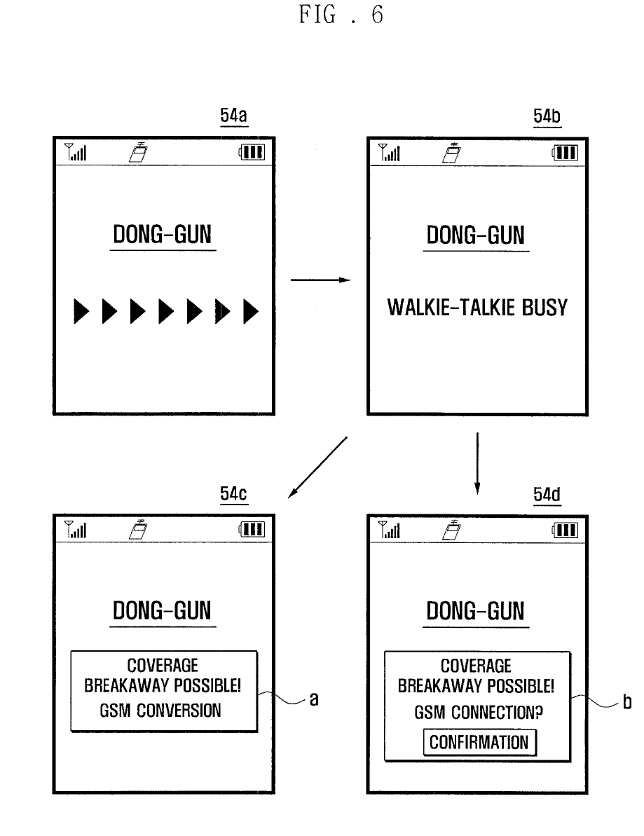

FIG. 6 is a screen illustrating an example of forming a communications channel based on a phone book illustrated in FIG. 5. Referring to FIG. 6, the portable device user can generate a key input signal for forming a communications channel with another portable device registered as “1. Dong-gun” based on the phone book illustrated in FIG. 5. To this end, user can select “1. Dong-gun” by using a direction key, a hotkey, and/or a numeric key. After the selection, a user can click a mobile communications module based send button or a digital walkie-talkie module based send button (not shown). To this end, the portable device can prepare a mobile communications module based send button and a digital walkie-talkie module based send button, and can classify the selection of communications module by pressing one send button for a long time to indicate one communication mode or a short time to indicate a second communication mode. Moreover, the portable device can output an option window (not shown) that can select a send button corresponding to a communications module, and can receive an input signal according to the user's selection. In the meantime, in case the portable device user selects item 154 (FIG. 5) and tries to form communications channel, the portable device can perform a signal transceiving process to form a communications channel based on at least one of the mobile communications module or the digital walkie-talkie module. At this time, in case digital walkie-talkie module can be used, the portable device can preferentially form a communication channel with the digital walkie-talkie module rather than with the mobile communications module. That is, in case a user activates the send button, the portable device can perform a signal transceiving process for forming communications channel based on the digital walkie-talkie module, as shown in screen 54a (FIG. 6). Then, in case a communication channel with “1. Dong-gun” is formed, the portable device can output a screen displaying that the walkie-talkie call is busy (in-use) as shown in screen 54b. If a channel formation failure is generated in the process where communications channel is formed based on the digital walkie-talkie module, the portable device can a form communication channel based on the mobile communications module. The failure of communications channel formation can include a case where the portable device is unable to receive a response signal from a corresponding portable device within a preset time, or a case where the number of times of repeatedly transmitting a signal of requesting channel formation is over a preset number of times. In the meantime, in the process where portable device user performs communications based on the digital walkie-talkie module, as the portable device user moves or the other portable device user moves, it might be occurred that one or the other device moves or breaks away from the area of coverage. In case the portable device performs communications with another portable device based on digital walkie-talkie module the portable device periodically detects the intensity of the reception signal. In case the intensity of reception signal is detected to be lower than a given level for a predetermined time, the portable device can output a warning message that alerts the user of a breakaway from the coverage area. That is, the portable device can output a “coverage breakaway possibility” message and a message (a) which indicates that communications channel will be formed based on the mobile communications module, e.g., GSM module to display unit as shown in screen 54c. The portable device can then activate the mobile communications module by using information of the other portable device as registered in the phone book (i.e., “1. Dong-gun”) to form the mobile communications channel. Moreover, the portable device outputs the coverage breakaway possibility message (see screen 54d, and a pop-up window (b) that queries whether the portable terminal will form a communications null based on the mobile communications module. In this case, a connection check is selected in the pop-up window, the portable device can display on the mobile communications terminal display the formation of a communications channel as shown in 54c.

In the above description, the setting of preferentially utilizing digital walkie-talkie module can be provided with a separate setting menu with respect to information of a user that can form a communication channel based on both a mobile communications module and a digital walkie-talkie module among information regarding other users registered in phone book. Accordingly, the portable device can preferentially activate the mobile communications module rather than the digital walkie-talkie module, according to user's setting.

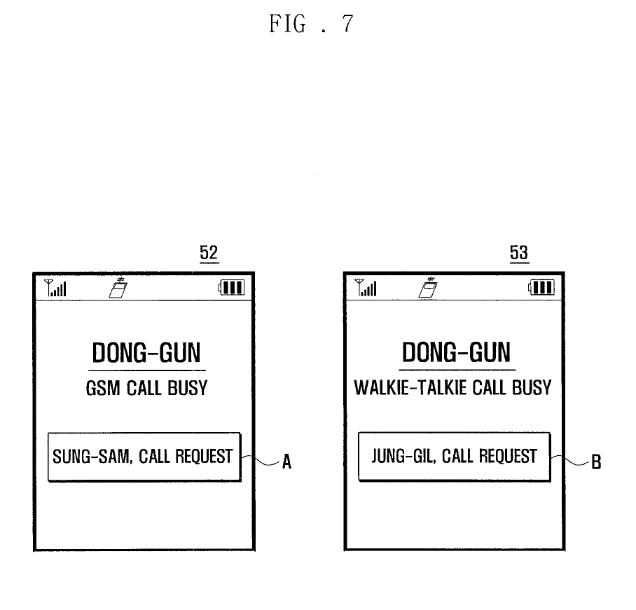

FIG. 7 is a drawing illustrating an example of screen during a call of portable device using a digital walkie-talkie module according to an exemplary embodiment of the present invention. Referring to FIG. 7, in screen 52, if the portable device of the present invention forms a communications channel with another portable device (e.g., “Dong-gun” shown in FIG. 5) based on a mobile communications module, e.g., GSM. Then, if the call is performed, the display unit can output a corresponding screen. At this time, if a call request message based on a mobile communications module is received from a second other portable device (e.g., “4. Sung-sam”), the portable device can output a first alert message (A) informing the user of the second other call request to display unit during the call indicating a “Sung-sam” call request. At this time, in case the call request comes from a portable device that is not registered in the phone book, the portable device can output the telephone number of a corresponding portable device to the display unit.

However, when the call request is from a known entity in the phone book, the first alerting message (A) can also indicate the communications module that the other portable device is based on. That is, in case the other portable device requests call based on a digital walkie-talkie module, the first alerting message (A) can output a message corresponding to “Requesting call to Sung-sam's walkie-talkie”, see screen 53. If the portable device of the present invention forms a communications channel with the other portable device registered as “Dong-gun” is based on the digital walkie-talkie module and performs a call, the display unit can output a screen displaying the information that a digital walkie-talkie module based call is busy.

At this time, if the portable device receives a signal informing call request from still another portable device (e.g., Jung-gil” in phone book shown in FIG. 5), the portable device can output a second alerting message (B) corresponding to “Requesting call to Jung-gil” similar to the mobile communications module indicating a call busy condition The second alerting message (B) can include a content informing the user that it is a call request based on communications module by which “Jung-gil” requested to call, i.e., mobile communications module based call request. In case information of the other portable device requesting call is not registered in phone book, the second alerting message (B) can output a telephone number instead of user information. That is, the display unit of the present invention includes an area that indicates that a communications channel is formed based on a digital walkie-talkie module or a mobile communications module, and an area which outputs call standby information corresponding to call request from other portable device.

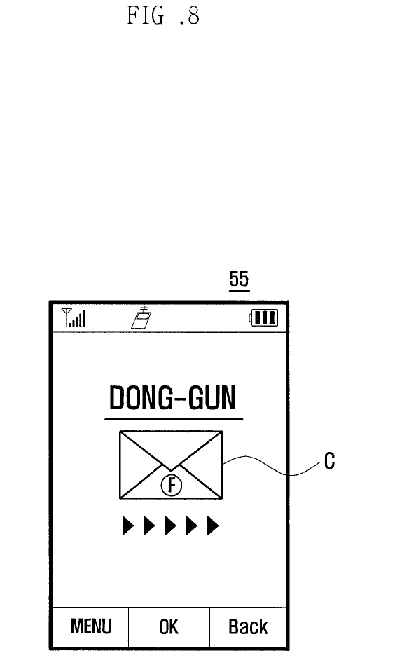

FIG. 8 is a drawing illustrating an example of message service screen of portable device using a digital walkie-talkie module according to an exemplary embodiment of the present invention.

Referring to FIG. 8, the display unit of portable device can output a screen which transmits a message service to the other portable device registered as “1. Dong-gun” in phone book shown in FIG. 5 based on the digital walkie-talkie module. At this time, the portable device can include index information informing the user of the use of the digital walkie-talkie module, e.g., icon “\textcircled{F}” in an icon area, which indicates message transmission so as to distinguish the message service from the mobile communications module based message service. That is, the portable device of the present invention can distinguish and display an image indicating a mobile communications module based message transmission and an image indicating a message transmission performed based on a digital walkie-talkie module. In the meantime, the portable device can support an input of “1. Dong-gun” registered in phone book to an input window to which a message receiver is inputted, after or before writing a message, so as to transmit the message based on the digital walkie-talkie module. Accordingly, if an input signal for the message transmission is sent from the input unit, the portable device searches a message receiver list. If an item which requested transmission to the digital walkie-talkie module exists in the receiver list, the portable device can send a message based on the digital walkie-talkie module. That is, in case digital walkie-talkie module is activated, the portable device can transmit a signal corresponding to a message corresponding to other portable device based on the digital walkie-talkie module. At this time, if portable device receives a response signal from the other portable device, the controller can output a message corresponding to the completion of message transmission to the display unit. Here, in case “1. Dong-gun” is registered in the message receiver list, the portable device can control the digital walkie-talkie module based message transmission, as a default mode. That is, as shown in FIG. 5, in case the other portable device registered as “1. Dong-gun” is recognized as a terminal that is available for both mobile communications module and digital walkie-talkie module, the portable device can preferentially activate the digital walkie-talkie module and can control the message transmission. In case message transmission failure is generated, the portable device can transmit a message that is written based on the mobile communications module. At this time, message transmission failure can be a case where a response signal does not exist within a preset time after the message transmission. In this case, portable device can transmit the messages for the preset number of times. In the meantime, in case the digital walkie-talkie module fails, portable device can output a message about failure, instead of transmitting a message based on the mobile communications module.

As described above, user interface of portable device using digital walkie-talkie module according to an exemplary embodiment of the present invention can support to easily and correctly select and use communications module in the process of using communications service based on a digital walkie-talkie module. In the meantime, in the above description, it was illustrated that digital walkie-talkie module is activated in the radio frequency unit call standby state, and a call is connected based on the radio frequency unit. However, the present invention activates digital walkie-talkie module in the radio frequency unit based call connection state, and can form a corresponding walkie-talkie communications channel. In this case, as described above, the controller transmits initialization message to other portable devices to inform the devices of a walkie-talkie frequency value used in stand-by mode and can form a walkie-talkie communications channel based on a corresponding frequency value. At this time, in addition to the method of transmitting initialization messages and setting a frequency value, a user can directly transmit a frequency value to be set through a voice command or can provide a separate message service. In the meantime, in the above description, the digital walkie-talkie module was illustrated to be built in the portable device 100 but the present invention is not limited to this. That is, the digital walkie-talkie module can be manufactured in a manner that it can be detachable from portable device. In case digital walkie-talkie module is manufactured with a detachable type, it is preferable that portable device more prepares an interface to which digital walkie-talkie module can be connected.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As would be recognized by those skilled in the art, when a general purpose computer is loaded with, or accesses, software or code for implementing the processing shown herein, the general purpose computer is transformed into a special purpose computer that may at least perform the processing shown herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A portable device using a digital walkie-talkie module, the portable device comprising:
a radio frequency unit which forms a call channel based on a mobile communications system;
a digital walkie-talkie module which forms a communications channel based on a public frequency band;
an input unit which generates an input signal for activation of at least one of the radio frequency unit and the digital walkie-talkie module;
an audio processing unit which outputs at least one of an audio signal received by the radio frequency unit and an audio signal received by the digital walkie-talkie module, and collects an inputted audio signal and sends the collected audio signal to one of the radio frequency unit and the digital walkie-talkie module; and
a controller which controls to process a digital signal sent from the digital walkie-talkie module and output the processed digital signal to the audio processing unit, or controls to process an inputted audio signal and send the processed audio signal it to the digital walkie-talkie module.

2. The portable device of claim 1, wherein the controller comprises:
a serial communications interface for transmitting and receiving a signal with the digital walkie-talkie module;
a codec which codes and decodes a signal transmitted and received from the radio frequency unit; and
a signal processing unit which processes a signal transmitted and received in the codec and a signal transmitted and received through the serial communications interface.

3. The portable device of claim 1, wherein the digital walkie-talkie module comprises:
a walkie-talkie package which transmits and receives an audio signal to/from the controller;
a power amplifier which amplifies a signal from the walkie-talkie package;
a walkie-talkie antenna which radiates the amplified signal to the public frequency band, and receives a signal radiated on the public frequency band and send the received signal to the walkie-talkie package; and
a frequency oscillator for generation of a reference signal of the walkie-talkie package.

4. The portable device of claim 1, further comprising a display unit which provides an alert of a corresponding call reception, in case a radio frequency unit based call is received during an activation of the digital walkie-talkie module.

5. The portable device of claim 1, wherein the controller:
transmits a “busy” alarm to another portable terminal which transmitted a call based on a radio frequency unit, in case the radio frequency unit based call is received during activation of the digital walkie-talkie module, and an input signal corresponding to a rejection of the call is generated;
cancels a communications channel based on the digital walkie-talkie module, in case an input signal which selects formation of a call channel based on the radio frequency unit is generated during formation of the communications channel based on the digital walkie-talkie module;
transmits an initialization message including a preset frequency value to another portable device forming a call channel, in case an input signal for activating the digital walkie-talkie module is generated from the input unit during the forming of a the call channel based on the radio frequency unit; and
performs a frequency setting of the digital walkie-talkie module based on a frequency value included in the initialization message, in case the initialization message is received from the other portable device.

6. A method of controlling a portable device including a radio frequency unit forming a call channel based on a mobile communications system and a digital walkie-talkie module forming a communications channel based on a public frequency band, the method comprising:
forming a call channel based on the radio frequency unit;
forming a communications channel by performing a frequency setting for the communications channel formation, in case an input signal for activation of the digital walkie-talkie module based communications channel is generated during the call channel formation; and
processing a signal transmitted and received through the digital walkie-talkie module by a signal processing unit which processes a signal transmitted and received through the radio frequency unit.

7. The method of claim 6, wherein processing a signal comprises:
outputting processed signal data through an audio processing unit; and
processing an audio signal collected by the audio processing unit and transmitting to the digital walkie-talkie module.

8. The method of claim 6, further comprising removing the radio frequency unit based call channel.

9. The method of claim 6, further comprising one of:
alerting a corresponding call reception, in case the radio frequency unit based call is received during activation of the digital walkie-talkie module;
cancelling the digital walkie-talkie module based communications channel, if an input signal selecting formation of a call channel using the radio frequency unit; and
transmitting a “busy” alarm to the other portable terminal that transmitted the radio frequency unit based call, in case the radio frequency unit based call is received during activation of the digital walkie-talkie module, and an input signal corresponding to a rejection of the call is generated.

10. The method of claim 6, wherein forming a communications channel comprises: writing an initialization message including a preset frequency value, and transmitting the initialization message to the other portable device forming the call channel.

11. The method of claim 10, wherein forming a communications channel comprises:
receiving an initialization message from the other portable device; and
performing a frequency setting of digital walkie-talkie module based on a frequency value included in the initialization message.

12. A method of controlling a portable device including a radio frequency unit forming a call channel based on a mobile communications system and a digital walkie-talkie module forming a communications channel based on a public frequency band, the method comprising:
forming a communications channel based on the digital walkie-talkie module; and
processing a signal received through the digital walkie-talkie module by a signal processing unit which may also process a signal received through the radio frequency unit.

13. The method of claim 12, wherein processing a signal comprises:
outputting processed signal data through an audio processing unit; and
processing an audio signal collected by the audio processing unit and transmitting the collected signal to the digital walkie-talkie module.

14. The method of claim 12, further comprising one of:
indicating a corresponding call reception, in case the radio frequency unit based call is received during activation of the digital walkie-talkie module;
cancelling the digital walkie-talkie module based communications channel, if an input signal selecting formation of a call channel using the radio frequency unit; and
transmitting a “busy” alarm to the other portable terminal that transmitted the radio frequency unit based call, in case the radio frequency unit based call is received during activation of the digital walkie-talkie module, and an input signal corresponding to a rejection of the call is generated.

15. A user interface of a portable device including a digital walkie-talkie module and a mobile communications module, the user interface comprising:
a user information area which outputs user information of at least one other portable device; and
a communications module area which outputs information which indicates whether the user information is possible to form a communications channel or indicates that a communications channel is formed based on at least one of the digital walkie-talkie module and the mobile communications module.

16. The user interface of claim 15, further comprising an indicator area displaying an icon indicating an activation of the digital walkie-talkie module or an activation of the mobile communications module.

17. The user interface of claim 15, wherein the user information area and the communications module area are part of a phone book area.

18. The user interface of claim 15, wherein the user information area and the communications module area are outputted to a stand-by screen according to a user input.

19. The user interface of claim 15, wherein the communications module area comprises at least one of:
a digital walkie-talkie module icon area which outputs a digital walkie-talkie module icon corresponding to the digital walkie-talkie module; and
a mobile communications module icon area which outputs a mobile communications module icon corresponding to the mobile communications module.

20. The user interface of claim 19, wherein the digital walkie-talkie module icon comprises at least one of an icon that indicates that it is possible to form a communications channel based on the digital walkie-talkie module and an icon that indicates that it is not possible to form a communications channel based on the digital walkie-talkie module, and is outputted according to a history of performing communications by using other portable device and the digital walkie-talkie module.

21. The user interface of claim 19, wherein the mobile communications module icon is one of:
an icon which indicates that it is possible to form a communications channel based on the mobile communications module; and
an icon which indicates that it is not possible to form a communications channel based on the mobile communications module.

22. The user interface of claim 15, wherein the communication module area comprises at least one of:
an area which outputs a message about a breakaway possibility or a breakaway, in case a coverage with another portable device breaks away from a preset value, after a communications channel is formed based on the digital walkie-talkie module;
an area which outputs a message which informs of a user of a communication channel conversion based on the mobile communications module or a pop-up window for selecting a communication channel conversion based on the mobile communications module;
an area which outputs a first image indicating a message service usage based on the mobile communications walkie-talkie module; and
an area which outputs a second image distinguished from the first image, in case of performing message transmission based on the digital walkie-talkie module.

23. The user interface of claim 15, wherein the communication module area comprises:
an area which indicates a communications channel formation based on one of the digital walkie-talkie module and the mobile communications module; and
an area which outputs user information corresponding to the other portable device in case of receiving a call request signal from the other portable device.

24. A method of providing a user interface of a portable device including a mobile communications module forming a communications channel based on a mobile communications system and a digital walkie-talkie module forming a communications channel based on a public frequency band, the method comprising:
activating a phone book according to one of: a menu selection and a shortcut key input;
outputting user information of at least one other portable device according to the activation of phone book;
checking whether from the user information it is possible to form a communications channel according to a given cycle based on a digital walkie-talkie module; and
displaying the user information which is possible to form a communications channel based on the digital walkie-talkie module in such a manner that it can be distinguished from other user information.

25. The method of claim 24, further comprising outputting an icon indicating an activation state of at least one of the digital walkie-talkie module and an activation of the mobile communications module to an indicator area.

26. The method of claim 24, wherein displaying the user information comprises at least one of:
outputting a first icon which indicates that it is possible to form a communications channel based on the digital walkie-talkie module;
outputting a second icon which indicates that it is not possible to form a communications channel based on the digital walkie-talkie module; and
outputting at least one of the first icon and the second icon to the user information of the other portable device which has a history of performing a communication, when generating an input signal for checking the history of performing the communication using the other portable device and the digital walkie-talkie module.

27. The method of claim 24, further comprising one of:
outputting a message about a breakaway possibility or a breakaway, in case a coverage with the other portable device is less than a preset value, after a communications channel is formed with the other portable device based on the digital walkie-talkie module; and
outputting at least one of: a message which informs of the user of a communication channel conversion based on the mobile communications module and a pop-up window for selecting a communication channel conversion based on the mobile communications module;

28. The method of claim 24, further comprising:
outputting a message write window for writing a message to be transmitted to the other portable device having one user information among the outputted user information; and
transmitting the written message based on the digital walkie-talkie module.

29. The method of claim 28, wherein transmitting the written message comprises outputting an image indicating that the message is transmitted based on the digital walkie-talkie module.

30. The method of claim 24, further comprising one of:
outputting information corresponding to a call standby mode, in case of receiving a call request signal from the other portable device during a digital walkie-talkie module based call;
outputting an icon indicating a communications possibility based on the mobile communications module;
outputting an image distinguished from the digital walkie-talkie module based message transmission, when transmitting a message based on the mobile communications module; and
outputting user information of the other portable device, when receiving a digital walkie-talkie module based call request from the other portable device during a formation of a call channel based on the mobile communications module.
